(19) United States
(12) Patent Application Publication
(10) Pub. No.: US 2024/0122096 A1
(43) Pub. Date: Apr. 18, 2024

(54) METHODS, SYSTEMS, APPARATUSES, AND DEVICES FOR FACILITATING MAINTAINING OF LAWNS

(71) Applicant: Edwin Williams, Chicago, IL (US)

(72) Inventor: Edwin Williams, Chicago, IL (US)

(73) Assignee: Photonix Technology LTD, Chicago, IL (US)

(21) Appl. No.: 17/966,998

(22) Filed: Oct. 17, 2022

(51) Int. Cl. A01C 15/00; A01D 43/14

(52) U.S. Cl. CPC A01C 15/005; A01D 43/14

(57) ABSTRACT

An apparatus for facilitating maintaining of lawns. The apparatus comprises a body, wheel assemblies, and a material spreading assembly. Further, the material spreading assembly comprises a bottom container, a top container, a control mechanism, and a spreading mechanism. Further, the bottom container defines a bottom chamber including a first inlet and a first outlet. Further, the top container defines a top chamber including a second inlet and a second outlet. Further, the top container transfers a material received into the top chamber to the bottom chamber. Further, the bottom container dispenses the material received in the bottom chamber through the first outlet. Further, the control mechanism is coupled with the top chamber and allows the transferring of the material with a transferring rate. Further, the spreading mechanism is disposed in the bottom chamber for dispensing the material received in the bottom chamber through the first outlet in a dispensing area.

### FIELD OF THE INVENTION

Generally, the present disclosure relates to the field of plant husbandry. More specifically, the present disclosure relates to methods, systems, apparatuses, and devices for facilitating maintaining of lawns.

### BACKGROUND OF THE INVENTION

Existing devices for lawn maintenance are specifically designed for mowing down the grass of lawns. As a result, different lawn maintenance devices are needed that irrigate the grass in addition to mowing down the grass. Further, different lawn maintenance devices are also needed for spraying the grass with fertilizers or pesticides. Further, the existing devices for lawn maintenance spray a fixed quantity of substance over a fixed area. As a result, different lawn maintenance devices are needed that spray variable quantities of substances over variable areas.

Therefore, there is a need for improved methods, systems, apparatuses, and devices for facilitating maintaining of lawns that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating maintaining of lawns, in accordance with some embodiments. Accordingly, the apparatus may include a body, a plurality of pairs of wheel assemblies, and a material spreading assembly. Further, the plurality of pairs of wheel assemblies may be attached to the body. Further, the material spreading assembly may include a bottom container, a top container, a control mechanism, and a spreading mechanism. Further, the bottom container may be attached to a bottom side of the body. Further, the bottom container defines a bottom chamber including a first inlet and at least one first outlet. Further, the top container may be included within the body above the bottom container. Further, the top container defines a top chamber including a second inlet and a second outlet. Further, the top container transfers at least one material received into the top chamber from the second inlet to the bottom chamber through the second outlet. Further, the bottom container receives the at least one material in the bottom chamber through the first inlet based on the transferring of the at least one material through the second outlet. Further, the bottom container dispenses the at least one material received in the bottom chamber through the at least one first outlet. Further, the control mechanism may be coupled with the top chamber. Further, the control mechanism may be configured for allowing the transferring of the at least one material from the top chamber to the bottom chamber with a transferring rate. Further, the spreading mechanism may be disposed in the bottom chamber. Further, the spreading mechanism may be configured for dispensing the at least one material received in the bottom chamber through the at least one first outlet in a dispensing area.

Further disclosed herein is an apparatus for facilitating maintaining of lawns, in accordance with some embodiments. Accordingly, the apparatus may include a body, a plurality of pairs of wheel assemblies, a material spreading assembly, at least one sensor, and a processing device. Further, the plurality of pairs of wheel assemblies may be attached to the body. Further, the material spreading assembly may include a bottom container, a top container, a control mechanism, and a spreading mechanism. Further, the bottom container may be attached to a bottom side of the body. Further, the bottom container defines a bottom chamber including a first inlet and at least one first outlet. Further, the top container may be included within the body above the bottom container. Further, the top container defines a top chamber including a second inlet and a second outlet. Further, the top container transfers at least one material received into the top chamber from the second inlet to the bottom chamber through the second outlet. Further, the bottom container receives the at least one material in the bottom chamber through the first inlet based on the transferring of the at least one material through the second outlet. Further, the bottom container dispenses the at least one material received in the bottom chamber through the at least one first outlet. Further, the control mechanism may be coupled with the top chamber. Further, the control mechanism may be configured for allowing the transferring of the at least one material from the top chamber to the bottom chamber with a transferring rate. Further, the spreading mechanism may be disposed in the bottom chamber. Further, the spreading mechanism may be configured for dispensing the at least one material received in the bottom chamber through the at least one first outlet in a dispensing area. Further, the at least one sensor may be configured for generating at least one sensor data based on detecting at least one movement characteristic associated with a movement of the apparatus on at least one surface. Further, the processing device may be communicatively coupled with the at least one sensor. Further, the processing device may be configured for analyzing the at least one sensor data. Further, the processing device may be configured for determining at least one of the transferring rate and the dispensing area for the movement of the apparatus based on the analyzing of the at least one sensor data and a requirement of the at least one material for grass associated with at least one lawn. Further, the processing device may be configured for generating at least one of a first command and a second command for at least one of the control mechanism and the spreading mechanism based on the determining. Further, the processing device may be communicatively coupled to at least one of the control mechanism and the spreading mechanism. Further, at least one of the allowing of the transferring of the at least one material with the transferring rate and the dispensing of the at least one material in the dispensing area may be based on at least one of the first command and the second command.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a bottom perspective view of an apparatus for facilitating maintaining of lawns, in accordance with some embodiments.

FIG. 2 is a rear perspective partial view of the apparatus, in accordance with some embodiments.

FIG. 3 is a top rear perspective partial view of the apparatus, in accordance with some embodiments.

FIG. 4 is a top rear perspective partial view of the apparatus, in accordance with some embodiments.

FIG. 5 is a top front perspective partial view of the apparatus, in accordance with some embodiments.

FIG. 6 is a bottom perspective view of the apparatus, in accordance with some embodiments.

FIG. 7 is a bottom perspective view of the apparatus, in accordance with some embodiments.

FIG. 8 is a bottom perspective view of the apparatus, in accordance with some embodiments.

FIG. 9 is a bottom perspective view of the apparatus, in accordance with some embodiments.

FIG. 10 is a top rear perspective partial view of the apparatus, in accordance with some embodiments.

FIG. 11 is a top side perspective partial view of the apparatus, in accordance with some embodiments.

FIG. 12 is a top side perspective view of the apparatus, in accordance with some embodiments.

FIG. 13 is a side perspective partial view of the apparatus, in accordance with some embodiments.

FIG. 14 is a front view of an apparatus for facilitating maintaining of lawns, in accordance with some embodiments.

FIG. 15 is a side view of the apparatus, in accordance with some embodiments.

FIG. 16 is a top perspective view of the apparatus, in accordance with some embodiments.

FIG. 17 is a rear view of the apparatus, in accordance with some embodiments.

FIG. 18 is a top view of the apparatus, in accordance with some embodiments.

FIG. 19 is a side view of the apparatus, in accordance with some embodiments.

FIG. 20 is a top view of the user panel of the apparatus, in accordance with some embodiments.

FIG. 21 is a top view of the user panel of the apparatus, in accordance with some embodiments.

FIG. 22 is a front top perspective view of an apparatus for facilitating maintaining of lawns, in accordance with some embodiments.

FIG. 23 is a rear top perspective view of the apparatus, in accordance with some embodiments.

FIG. 24 is a top perspective view of the apparatus, in accordance with some embodiments.

FIG. 25 is a rear view of the apparatus, in accordance with some embodiments.

FIG. 26 is a top view of the user panel of the apparatus, in accordance with some embodiments.

FIG. 27 is a schematic of an electronic circuit of the apparatus, in accordance with some embodiments.

FIG. 28 is a bottom perspective view of an apparatus for facilitating maintaining of lawns, in accordance with some embodiments.

FIG. 29 is an illustration of an online platform consistent with various embodiments of the present disclosure.

FIG. 30 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating maintaining of lawns, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the processing device may include a computing device comprising a processing unit. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the communication device may be a computing device comprising a communication connection for communicating with other external devices. Further, the server computer may include a storage device configured for performing data storage and/or data retrieval operations. In general, the storage device may be configured for providing reliable storage of digital information. Accordingly, in some embodiments, the storage device may be based on technologies such as but not limited to, data compression, data backup, data redundancy, deduplication, error correction, data finger-printing, role based access control, and so on. Further, the storage device may be a computing device with a memory.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for facilitating maintaining of lawns.

Further, the present disclosure describes a machine for fertilizing the grass on the lawns. Further, the machine is equipped with an internal compartment that the user can fill with the appropriate fertilizer. The compartment is equipped with a movable internal plate that controls the flow rate to use the fertilizer. An electric motor turns a rotor where the fertilizer will be dropped. Due to its geometry and the centrifugal force, when spun the fertilizer is sprinkled from it. The user can control the rotor speed (more speed increases the radius to be fertilized) and the amount of fertilizer to be used. On a panel of the machine: the left button will turn on/off the blades. The right button on the bottom of the panel will turn on/off the Fertilizer (spreader) and the top one will move the lawnmower forward. The center holes will be for potentiometers, the right one for the height adjustment and the left for the amount of fertilizer to be spread. The Lawnmower will be powered by two 12V-12 Ah batteries (24V) which will be connected to the motor and the solar panel Controller. The Controller will manage the charge on the batteries. It automatically detects 12V or 24V batteries. And the maximum and minimum voltage can be set for the batteries. When batteries reach low voltage, the solar panel controller starts charging the batteries. When batteries reach total charge, then the solar panel controller stops charging the batteries. Further, the batteries used are Lead Acid types. Further, the motor has 750 W power and works on 24V. Further, the machine includes electronic devices such as a height adjustment and a fertilizer system. The height adjustment and the fertilizer system use a 2 cell Li-Ion battery (7.2V) which will be charged by the solar panel as well. The front wheel traction motors use the main 24V battery set. Further, the controller associated with the machine has two USB ports. Further, the controller may be used to charge or supply 5V for some other devices.

Further, the machine is a Photonix Lawnmower with a built-in user interface screen and a grass fertilizer integration system. Further, the solar panel associated with the machine may be of 30 W and generates a 1.2 A charging current. Further, a width of the machine may be 465 mm, a length of the machine may be 1008 mm, a height of the machine may be 405 mm, and a height of the machine with the handle may be 1039 mm.

Further, the machine may use a 500 W or 750 W DC motor direct drive and two 12V-15 A batteries or one 24V-15 A (Li-ion) battery.

Further, the height adjustment system uses a stepper motor on each axle working together. Further, the fertilizer compartment may be inside a grass bin of the machine and the user may control the speed and amount of fertilizer to be spread by the machine.

Further, the machine may be a solar lawnmower.

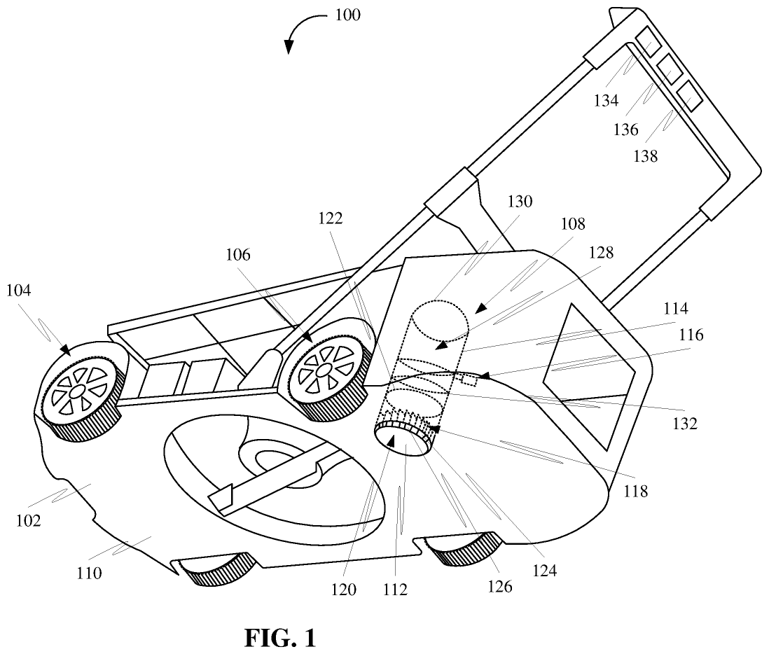

FIG. 1 is a bottom perspective view of an apparatus 100 for facilitating maintaining of lawns, in accordance with some embodiments. Accordingly, the apparatus 100 may include a body 102, a plurality of pairs of wheel assemblies 104-106, and a material spreading assembly 108. Further, the apparatus 100 may include a lawnmower. Further, the body 102 may define a chamber comprising a grass cutting opening and a grass dispensing opening. Further, the body 102 may include a blade assembly rotatably mounted in the chamber. Further, the blade assembly may cut at least one portion of grass received in the chamber through the grass cutting opening and transfer pieces of the grass to a grass bin through the grass dispensing opening. Further, the blade assembly may be actuated by a switch on a user panel mounted on a handle of the lawnmower.

Further, the plurality of pairs of wheel assemblies 104-106 may be attached to the body 102.

Further, the material spreading assembly 108 may include a bottom container 112, a top container 114, a control mechanism 116, and a spreading mechanism 118. Further, the bottom container 112 may be attached to a bottom side 110 of the body 102. Further, the bottom container 112 defines a bottom chamber 120 including a first inlet 122 and at least one first outlet 124-126. Further, the top container 114 may be included within the body 102 above the bottom container 112. Further, the top container 114 defines a top chamber 128 including a second inlet 130 and a second outlet 132. Further, the top container 114 transfers at least one material received into the top chamber 128 from the second inlet 130 to the bottom chamber 120 through the second outlet 132. Further, the at least one material may be a spraying substance, a dispensing substance, a blowing substance, etc. Further, the at least one material may include water, fertilizer solution, pesticide solution, etc. Further, the bottom container 112 receives the at least one material in the bottom chamber 120 through the first inlet 122 based on the transferring of the at least one material through the second outlet 132. Further, the bottom container 112 dispenses the at least one material received in the bottom chamber 120 through the at least one first outlet 124-126. Further, the control mechanism 116 may be coupled with the top chamber 128. Further, the control mechanism 116 may be configured for allowing the transferring of the at least one material from the top chamber 128 to the bottom chamber 120 with a transferring rate. Further, the transferring rate may be a mass flow rate of the at least one material through the second outlet 132. Further, the spreading mechanism 118 may be disposed in the bottom chamber 120. Further, the spreading mechanism 118 may be configured for dispensing the at least one material received in the bottom chamber 120 through the at least one first outlet 124-126 in a dispensing area. Further, the dispensing may include sprinkling, spraying, blowing, pouring, etc. Further, in some embodiments, the second outlet 132 may be coupled with the first inlet 122 for fluidly coupling the top chamber 128 to the bottom chamber 120.

Further, in some embodiments, the control mechanism 116 may include a plate 204 and a first actuator 202. Further, the plate 204 may be rotatably disposed in the top chamber 128. Further, the plate 204 may be configured to be rotated to one of a plurality of positions. Further, each of the plurality of positions corresponds to each of a plurality of areas of the second outlet 132. Further, the plate 204 covers one of a plurality of portions of the second outlet 132 in one of the plurality of positions. Further, the first actuator 202 may be operatably coupled with the plate 204. Further, the first actuator 202 may be configured for rotating the plate 204 to one of the plurality of positions. Further, the allowing of the transferring of the at least one material with the transferring rate may be based on the rotating of the plate 204 to one of the plurality of positions. Further, the first actuator 202 may be a DC motor, an Induction motor, a stepper motor, etc.

In further embodiments, the apparatus 100 may include a first input device 134. Further, the first input device 134 may be a switch disposed on the user panel. Further, the first input device 134 may be configured for receiving one of a plurality of first inputs associated with the first input device 134 from at least one user. Further, each of the plurality of first inputs corresponds to each of the plurality of positions of the plate 204. Further, the first actuator 202 may be communicatively coupled with the first input device 134. Further, the rotating of the plate 204 to one of the plurality of positions may be based on one of the plurality of first inputs.

Further, in some embodiments, the spreading mechanism 118 may include an impeller 208 and a second actuator 206. Further, the impeller 208 may be rotatably disposed in the bottom chamber 120. Further, the impeller 208 may be configured to be rotated with one of a plurality of speeds. Further, the second actuator 206 operatably coupled with the impeller 208. Further, the second actuator 206 may be configured for rotating the impeller 208 with one of the plurality of speeds. Further, the dispensing of the at least one material received in the bottom chamber 120 through the at least one first outlet 124-126 in the dispensing area may be based on the rotating of the impeller 208 with one of the plurality of speeds. Further, the dispensing area may be a region on a surface on which the at least one material may be dispensed. Further, the second actuator 204 may be a DC motor, an Induction motor, a stepper motor, etc.

In further embodiments, the apparatus 100 may include a second input device 136. Further, the second input device 136 may be configured for receiving one of a plurality of second inputs associated with the second input device 136 from at least one user. Further, each of the plurality of second inputs corresponds to each of the plurality of speeds associated with the impeller 208. Further, the second actuator 206 may be communicatively coupled with the second input device 136. Further, the second actuator 206 may be operatably coupled with the impeller 208. Further, the rotating of the impeller 208 with one of the plurality of speeds may be based on one of the plurality of second inputs.

In further embodiments, the apparatus 100 may include at least one height adjustment assembly 302. Further, the at least one height adjustment assembly 302 may be disposed on the body 102. Further, the height adjustment assembly may be operatably coupled with at least one axel 304 of at least one of the plurality of pairs of wheel assemblies 104-106. Further, the height adjustment assembly may be configured for adjusting a vertical distance between at least one central axis of at least one pair of wheels 306-308 of at least one of the plurality of pairs of wheel assemblies 104-106 and a bottom surface of the body 102.

Further, in some embodiments, at least one of the plurality of pairs of wheel assemblies 104-106 may include at least one pair of wheels (404-406 and 502-504) and a third actuator 402. Further, the at least one pair of wheels (404-406 and 502-504) may be configured to be rotated for moving the apparatus 100 on at least one surface with a plurality of apparatus speeds. Further, the third actuator 402 may be operatably coupled with the at least one pair of wheels (404-406 and 502-504). Further, the third actuator 402 may be configured for rotating the at least one pair of wheels (404-406 and 502-504) for the moving of the apparatus 100 with one of the plurality of apparatus speeds.

In further embodiments, the apparatus 100 may include a third input device 138. Further, the third input device 138 may be configured for receiving one of a plurality of third inputs associated with the third input device 138 from at least one user. Further, each of the plurality of third inputs corresponds to each of the plurality of apparatus speeds associated with the apparatus 100. Further, the third actuator 402 may be communicatively coupled with the third input device 138. Further, the rotating of the at least one pair of wheels (404-406 and 502-504) for the moving of the apparatus 100 with one of the plurality of apparatus speeds may be based on one of the plurality of third inputs.

In further embodiments, the apparatus 100 may include at least one sensor 602 and a processing device 604. Further, the at least one sensor 602 may be configured for generating at least one sensor data based on detecting at least one movement characteristic associated with a movement of the apparatus 100 on at least one surface. Further, the at least one movement characteristic may include a speed of the movement, a path of the movement, a direction of the movement, etc. Further, the processing device 604 may be communicatively coupled with the at least one sensor 602. Further, the processing device 604 may be configured for analyzing the at least one sensor data. Further, the analyzing may include analyzing using at least one machine learning model. Further, the at least one machine learning model may be trained to estimate the transferring rate of the at least one material such that the at least one material may be evenly distributed in the dispensing area. Further, the processing device 604 may be configured for determining at least one of the transferring rate and the dispensing area for the movement of the apparatus 100 based on the analyzing of the at least one sensor data and a requirement of the at least one material for grass associated with at least one lawn. Further, the requirement may be an amount of the at least one material required to be dispensed on the particular size of the dispensing area. Further, the processing device 604 may be configured for generating at least one of a first command and a second command for at least one of the control mechanism 116 and the spreading mechanism 118 based on the determining. Further, the processing device 604 may be communicatively coupled to at least one of the control mechanism 116 and the spreading mechanism 118. Further, at least one of the allowing of the transferring of the at least one material with the transferring rate and the dispensing of the at least one material in the dispensing area may be based on at least one of the first command and the second command.

In further embodiments, the apparatus 100 may include at least one first sensor 702. Further, the at least one first sensor 702 may be communicatively coupled with the processing device 604. Further, the at least one first sensor 702 may be configured for generating at least one first sensor data based on detecting at least one characteristic of the grass associated with the at least one lawn. Further, the at least one characteristic may include an amount of chlorophyll present in the grass, an amount of water present in the grass, a presence of infection in the grass, a presence of harmful microorganisms in the grass, a presence of insects in the grass, etc. Further, the processing device 604 may be configured for analyzing the at least one first sensor data. Further, the processing device 604 may be configured for generating the requirement of the grass associated with the at least one lawn based on the analyzing of the at least one first sensor data. Further, the requirement may include an amount of the at least one material needed by the grass. Further, the analyzing of the at least one sensor data and the requirement may be based on the generating of the requirement.

In further embodiments, the apparatus 100 may include at least one input device 902. Further, the at least one input device 902 may be communicatively coupled with the processing device 604. Further, the at least one input device 902 may be configured for receiving the requirement for the grass associated with the at least one lawn.

In further embodiments, the apparatus 100 may include at least one second sensor 802 and at least one output device 804. Further, the at least one second sensor 802 may be configured for generating at least one second sensor data based on detecting at least one characteristic of the dispensing area. Further, the at least one characteristic of the dispensing area may include a perimeter, a measure of area, a shape, etc. Further, the processing device 604 may be communicatively coupled with the at least one second sensor 802. Further, the processing device 604 may be configured for analyzing the at least one second sensor data. Further, the processing device 604 may be configured for generating a path for moving the apparatus 100 on the at least one lawn based on the analyzing of the at least one second sensor data and the analyzing of the at least one sensor data. Further, the moving of the apparatus 100 along the path evenly dispenses the at least one material on the grass of the at least one lawn. Further, the at least one output device 804 may be communicatively coupled with the processing device 604. Further, the at least one output device 804 may be configured for presenting the path.

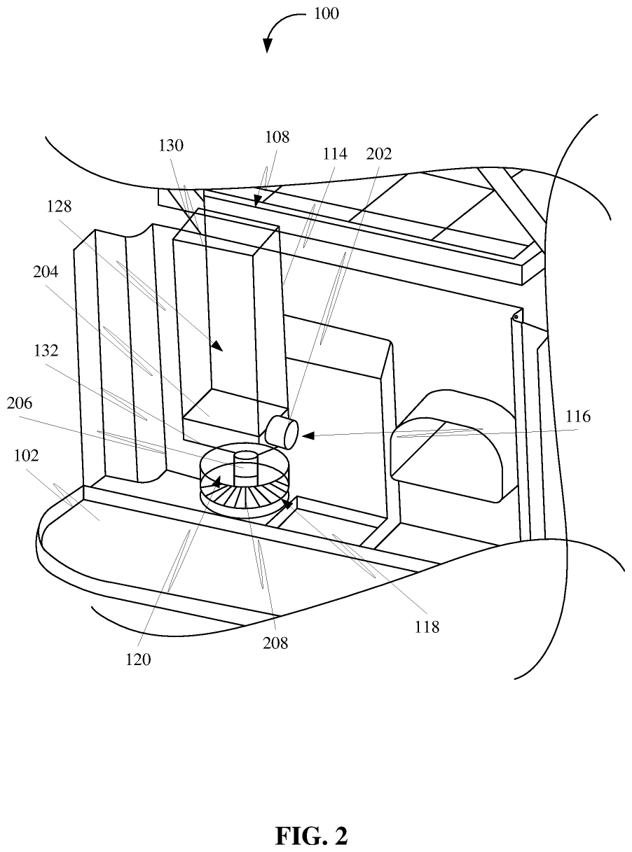

FIG. 2 is a rear perspective partial view of the apparatus 100, in accordance with some embodiments.

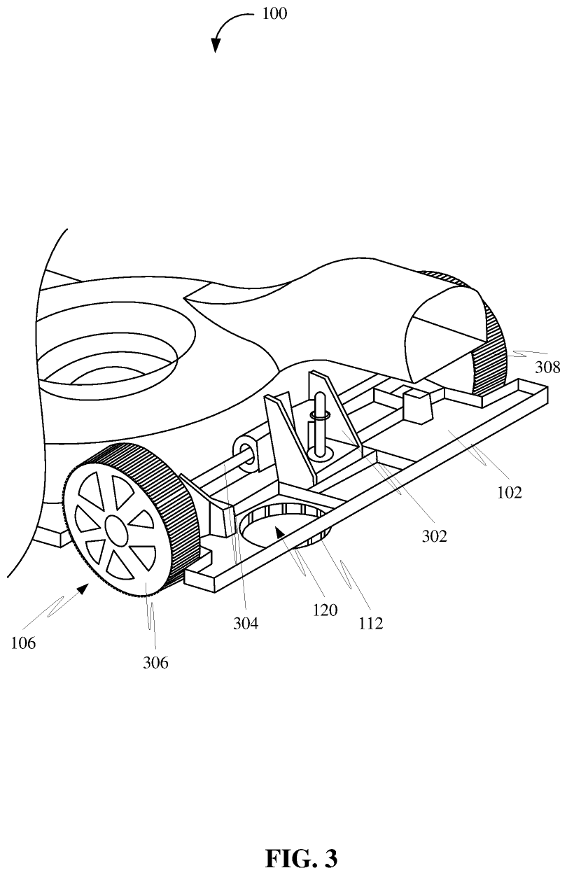

FIG. 3 is a top rear perspective partial view of the apparatus 100, in accordance with some embodiments.

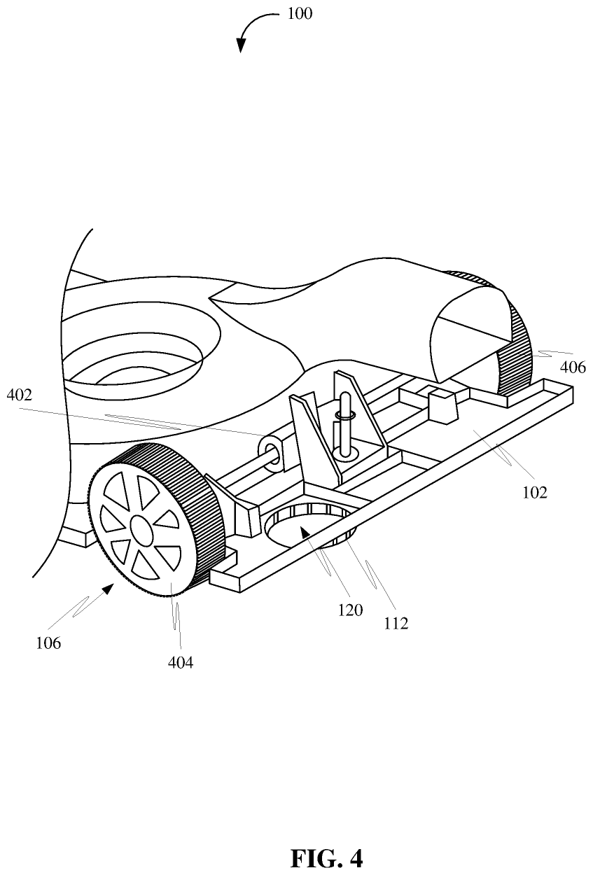

FIG. 4 is a top rear perspective partial view of the apparatus 100, in accordance with some embodiments.

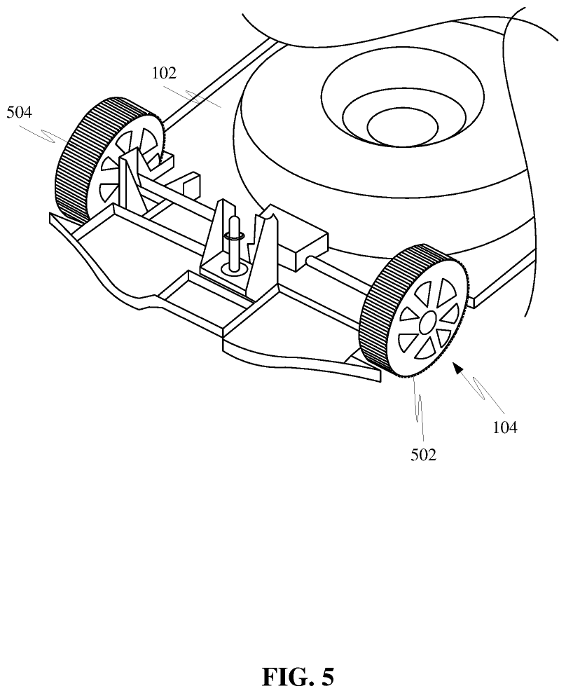

FIG. 5 is a top front perspective partial view of the apparatus 100, in accordance with some embodiments.

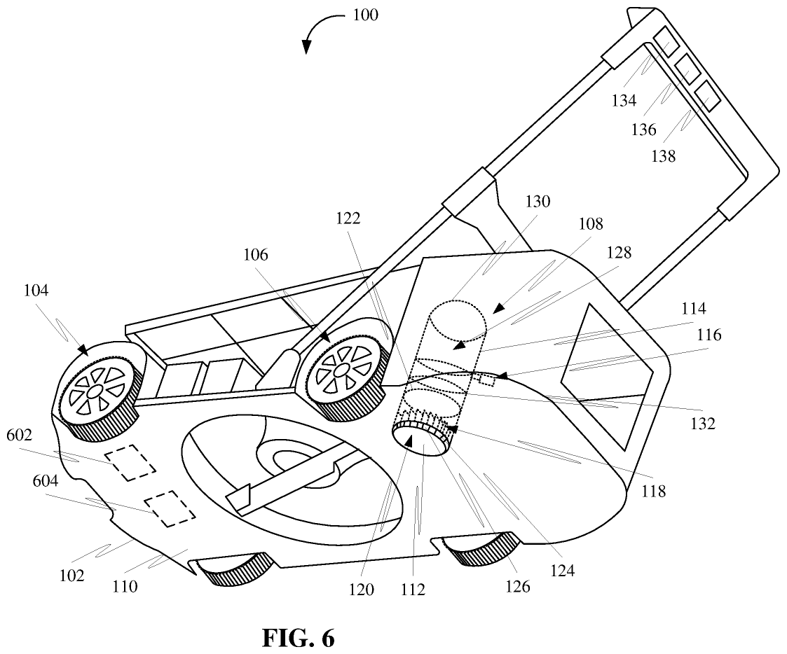

FIG. 6 is a bottom perspective view of the apparatus 100, in accordance with some embodiments.

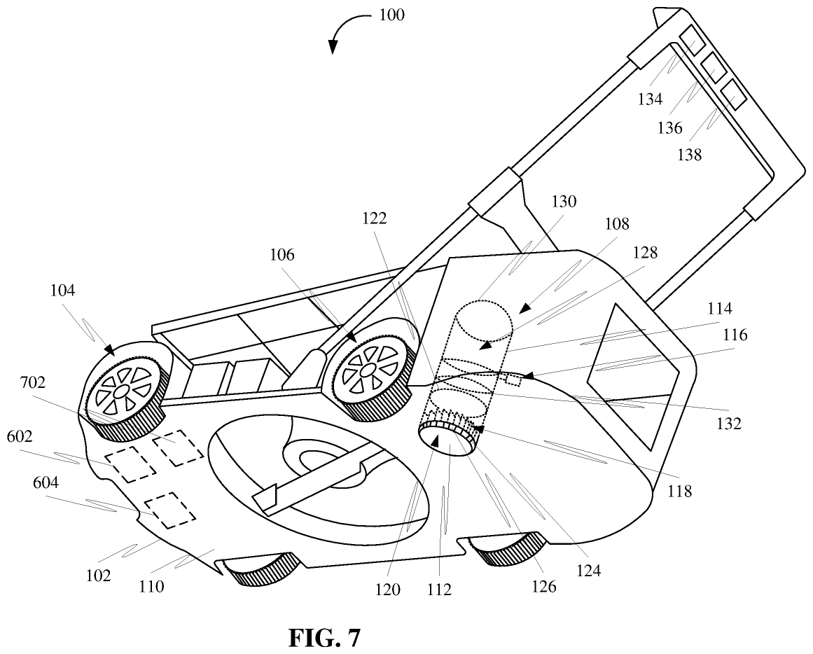

FIG. 7 is a bottom perspective view of the apparatus 100, in accordance with some embodiments.

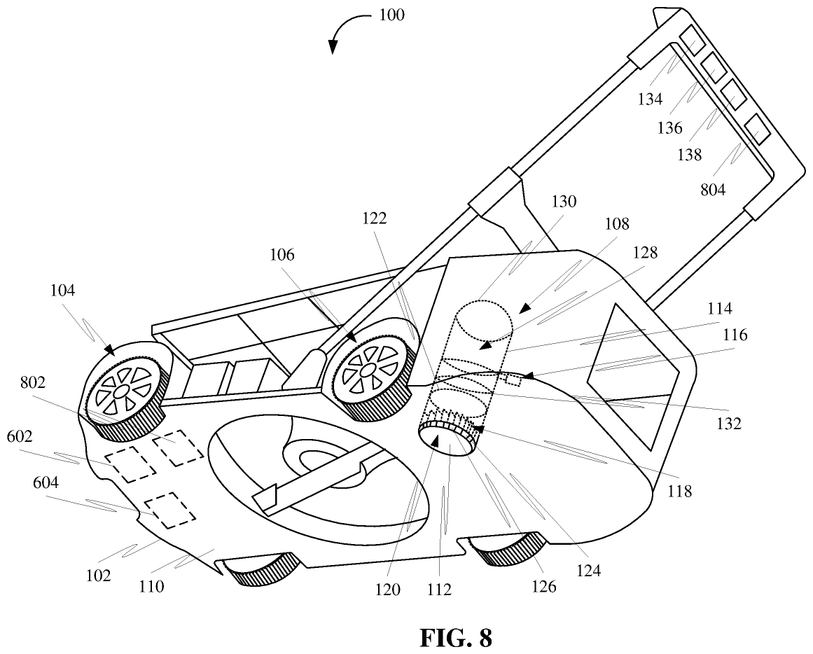

FIG. 8 is a bottom perspective view of the apparatus 100, in accordance with some embodiments.

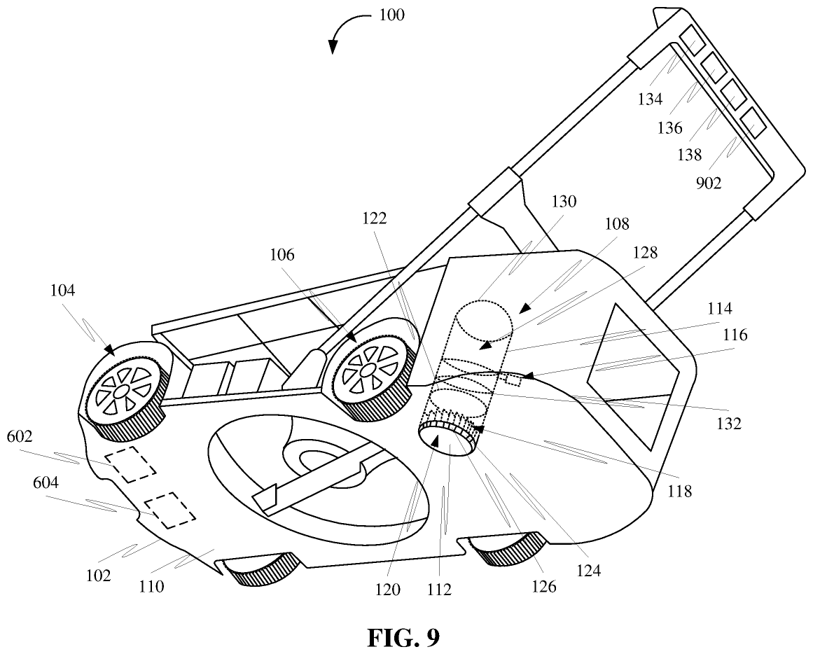

FIG. 9 is a bottom perspective view of the apparatus 100, in accordance with some embodiments.

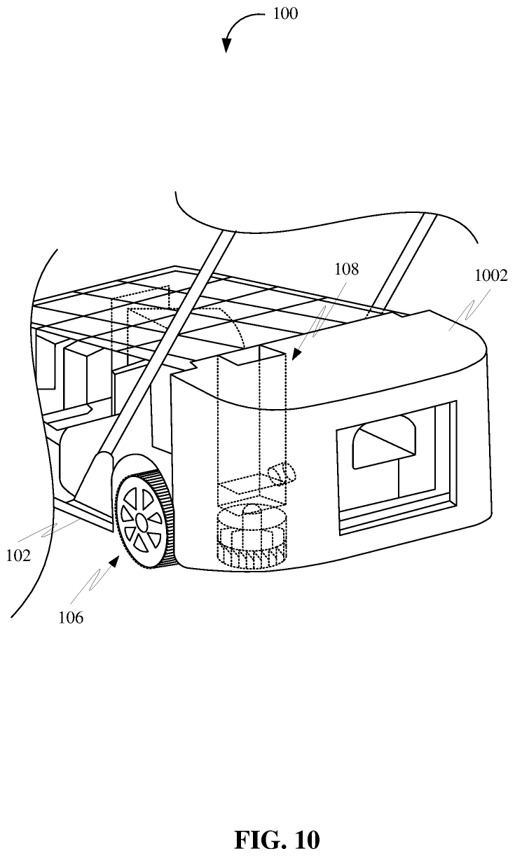

FIG. 10 is a top rear perspective partial view of the apparatus 100, in accordance with some embodiments. Further, the apparatus 100 may include a grass bin 1002. Further, the top container 1002 may be comprised in the grass bin 1002.

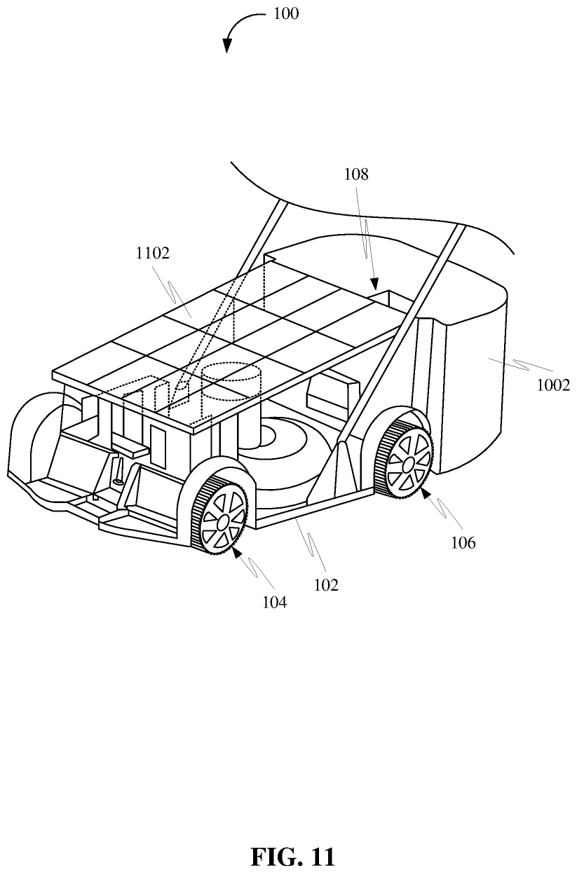

FIG. 11 is a top side perspective partial view of the apparatus 100, in accordance with some embodiments. Further, the apparatus 100 may include a solar panel 1102 for producing electrical energy for charging at least one battery. Further, the at least one battery may be electrically coupled with the control mechanism 116, the spreading mechanism 118, and actuators (202, 206, and 402) for powering the control mechanism 116, the spreading mechanism 118, and actuators (202, 206, and 402).

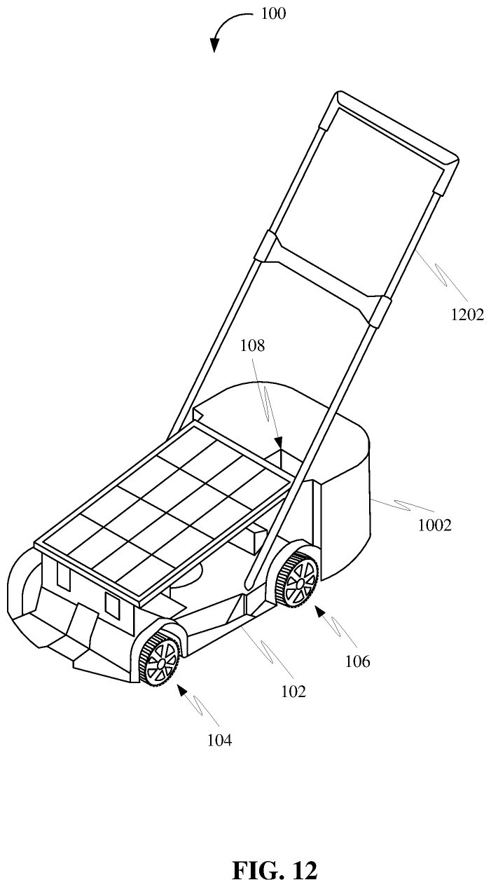

FIG. 12 is a top side perspective view of the apparatus 100, in accordance with some embodiments. Further, the apparatus 100 may include a handle 1202 extending away from the body 102 for guiding the movement of the apparatus 100.

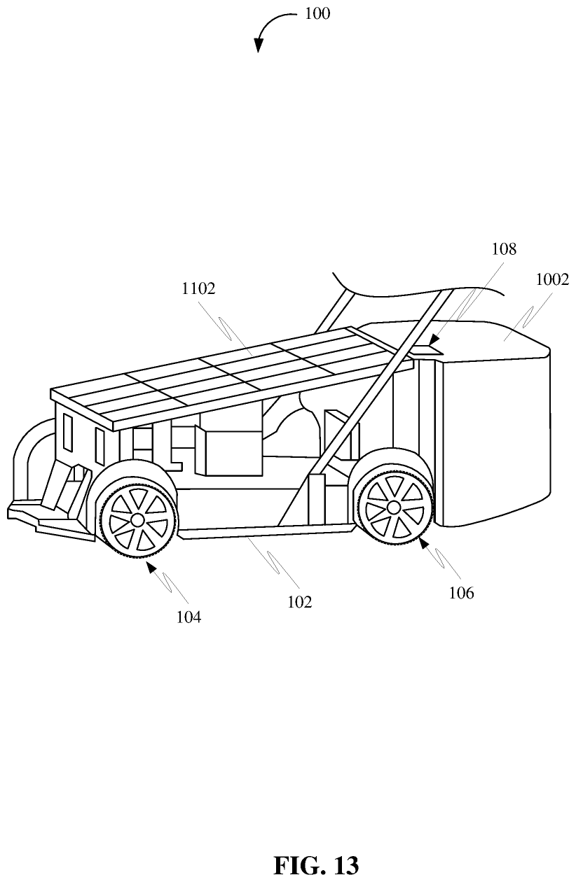

FIG. 13 is a side perspective partial view of the apparatus 100, in accordance with some embodiments.

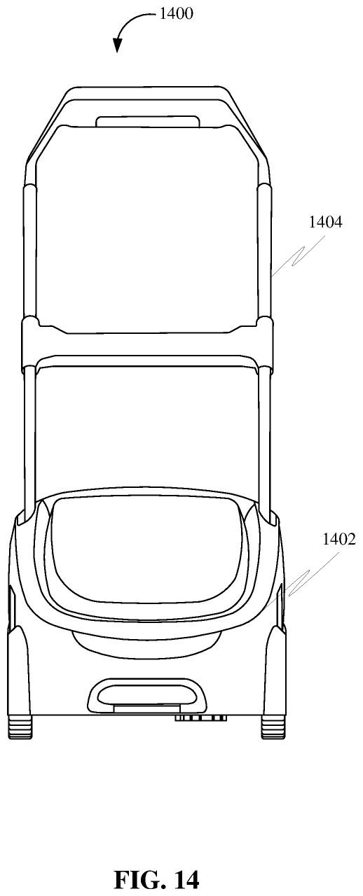

FIG. 14 is a front view of an apparatus 1400 for facilitating maintaining of lawns, in accordance with some embodiments. Further, the apparatus 1400 may include a body 1402 and a handle 1404 attached to the body 1402.

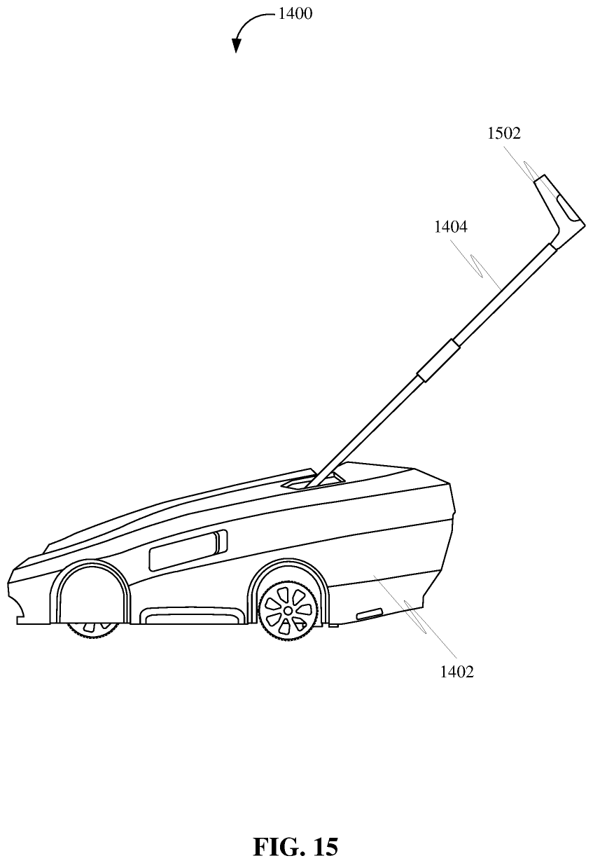

FIG. 15 is a side view of the apparatus 1400, in accordance with some embodiments. Further, the apparatus 1400 may include a user panel 1502 mounted on the handle 1404.

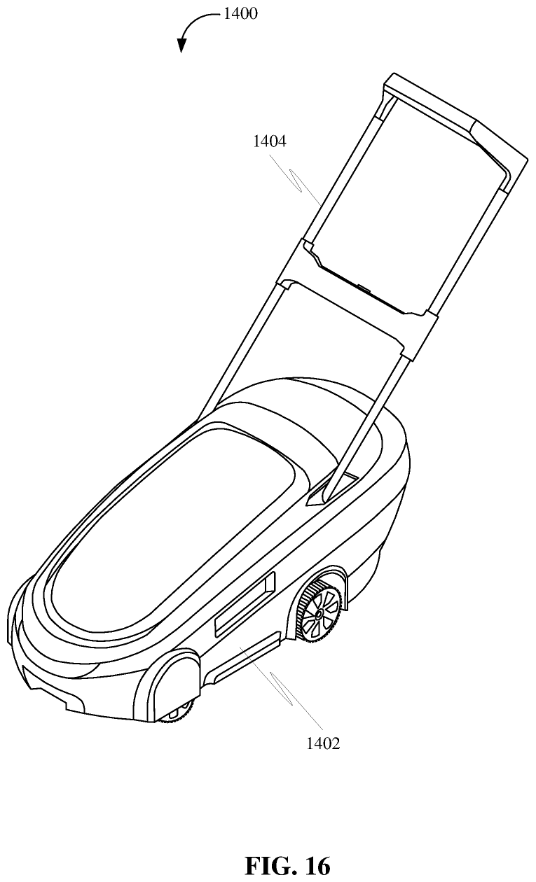

FIG. 16 is a top perspective view of the apparatus 1400, in accordance with some embodiments.

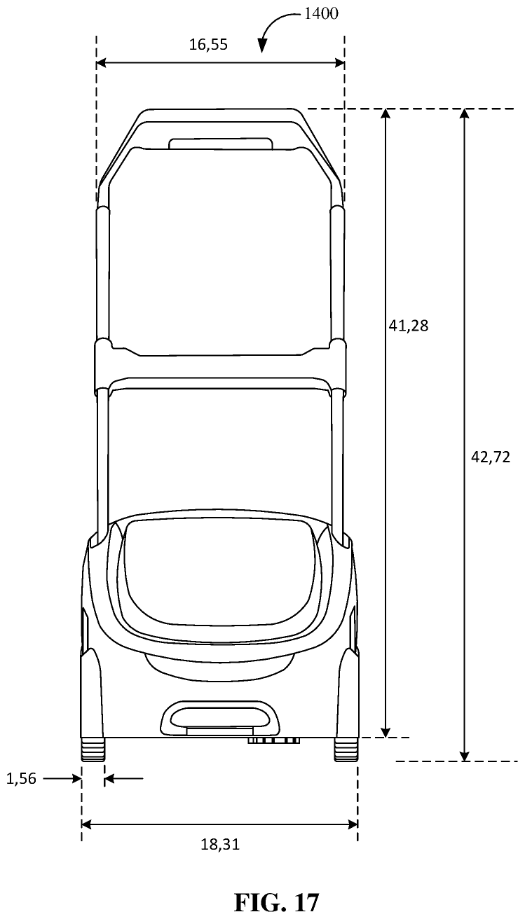

FIG. 17 is a rear view of the apparatus 1400, in accordance with some embodiments. Further, a width of the body 1402 may be 18.31 inches, a length of the apparatus 1400 without wheels may be 41.28 inches, a length of the apparatus 1400 with the wheels may be 42.72 inches, a width of the handle 1404 may be 16.55 inches, and a width of the wheels may be 1.56 inches.

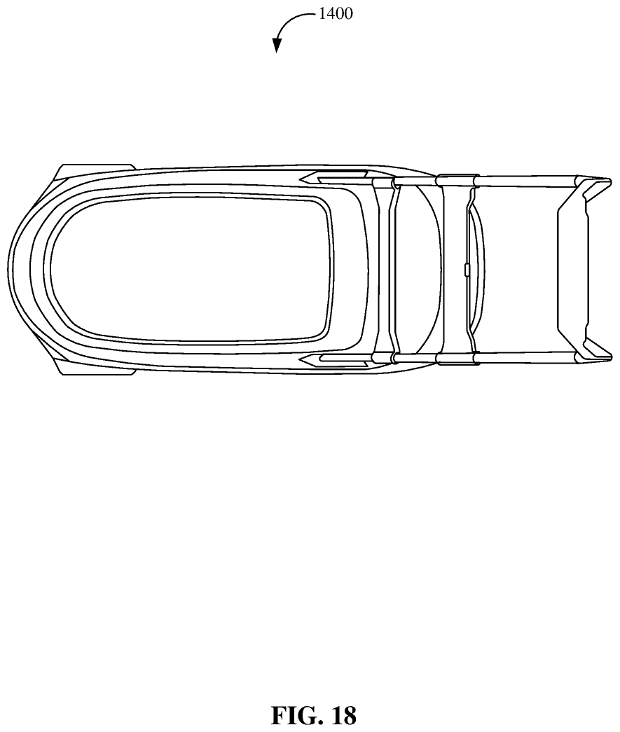

FIG. 18 is a top view of the apparatus 1400, in accordance with some embodiments.

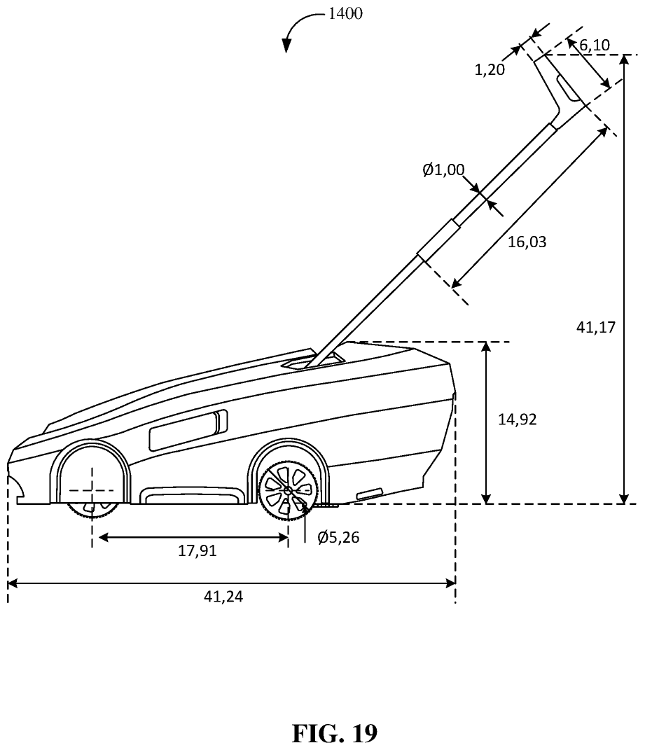

FIG. 19 is a side view of the apparatus 1400, in accordance with some embodiments. Further, a length of the body 1402 may be 41.24 inches, a length between the wheels may be 17.91 inches, a height of the body 1402 may be 14.92 inches, and a vertical height of the apparatus 1400 without the wheels may be 41.17 inches.

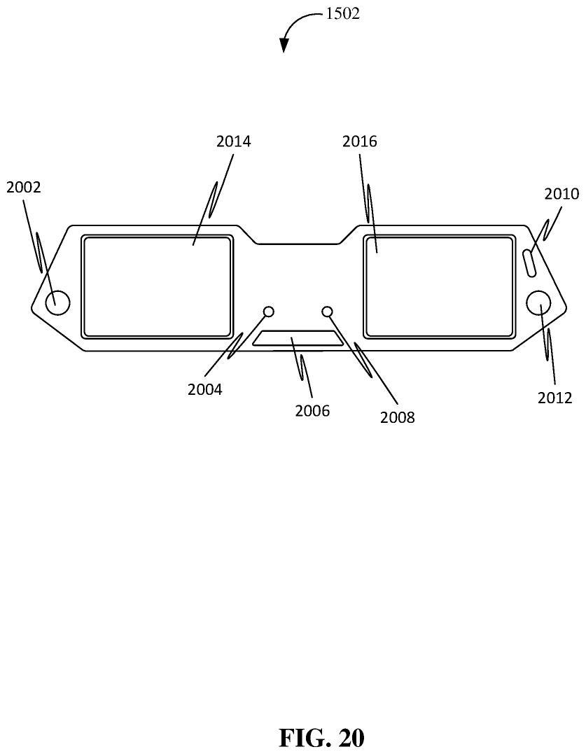

FIG. 20 is a top view of the user panel 1502 of the apparatus 1400, in accordance with some embodiments. Further, the user panel 1502 may include a blade ON/OFF switch 2002, a fertilizer flow control 2004, a master switch 2006, a height adjustment switch 2008, a move forward switch 2010, a fertilizer ON/OFF switch 2012, and at least one multifunctional display 2014-2016. Further, the blade ON/OFF switch 2002, the fertilizer flow control 2004, the master switch 2006, the height adjustment switch 2008, the move forward switch 2010, and the fertilizer ON/OFF switch 2012 may be input devices (134, 136, and 138). Further, the at least one multifunctional display 2014-2016 may be output devices (804).

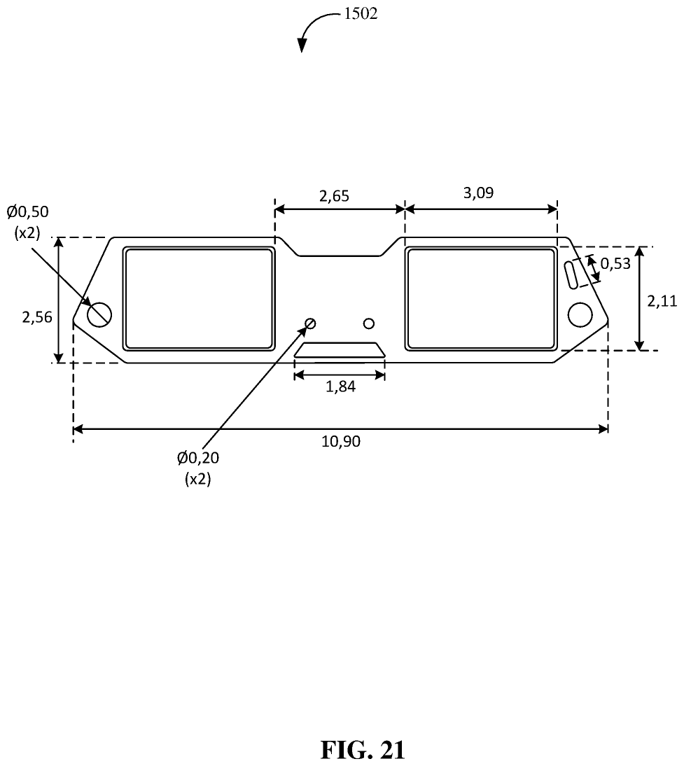

FIG. 21 is a top view of the user panel 1502 of the apparatus 1400, in accordance with some embodiments. Further, a length of the user panel 1502 may be 10.90 inches and a breadth of the user panel 1502 may be 2.56 inches.

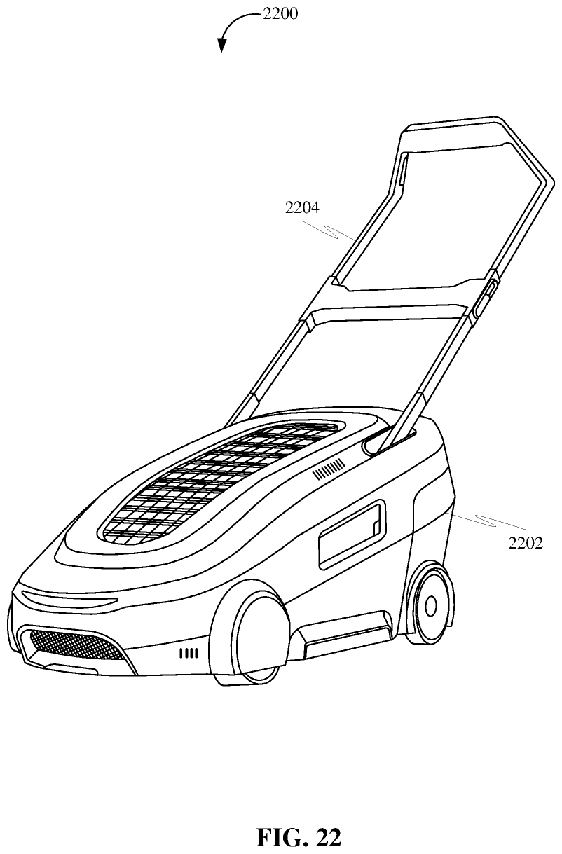

FIG. 22 is a front top perspective view of an apparatus 2200 for facilitating maintaining of lawns, in accordance with some embodiments. Further, the apparatus 2200 may include a body 2202 and a handle 2204.

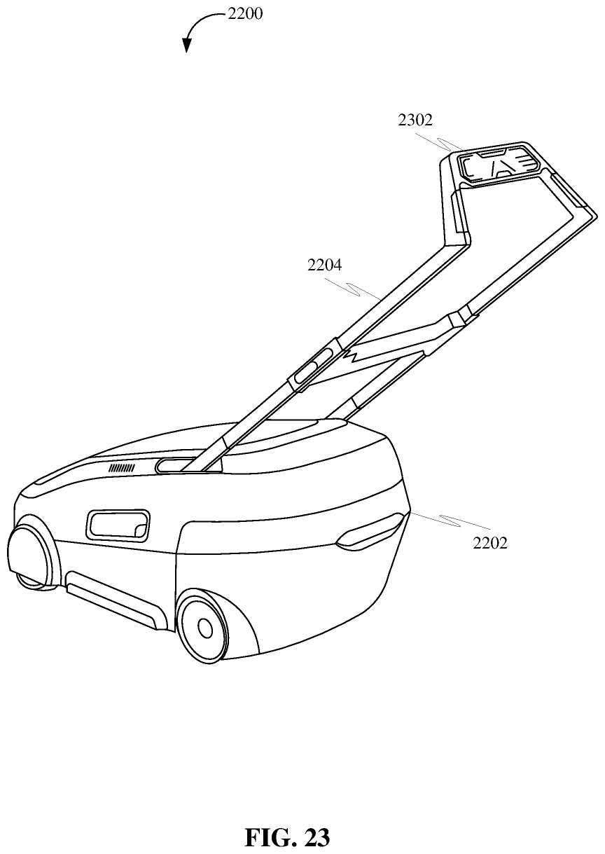

FIG. 23 is a rear top perspective view of the apparatus 2200, in accordance with some embodiments. Further, the apparatus 2200 may include a user panel 2302 mounted on the handle 2204.

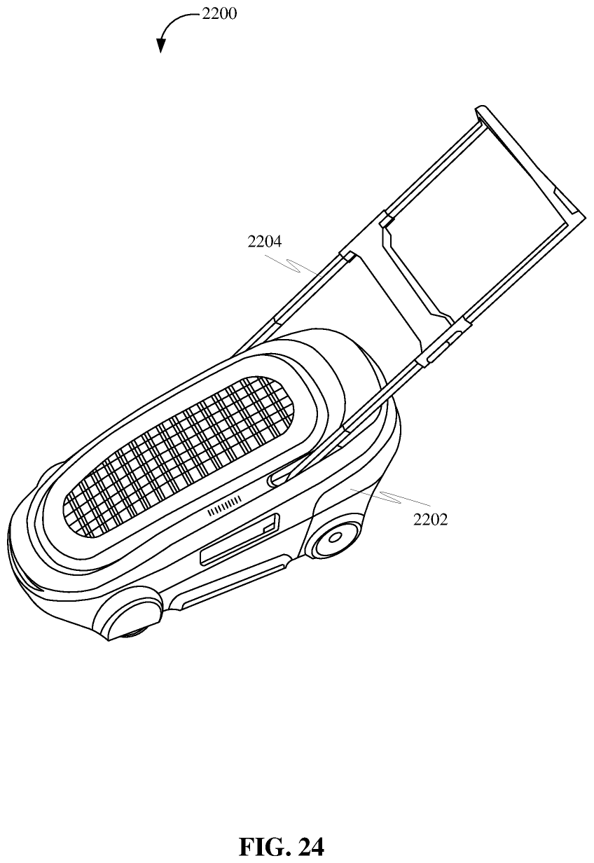

FIG. 24 is a top perspective view of the apparatus 2200, in accordance with some embodiments.

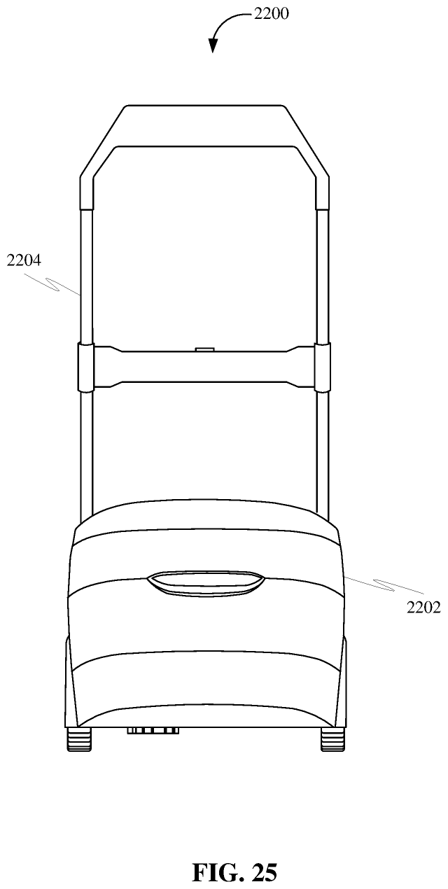

FIG. 25 is a rear view of the apparatus 2200, in accordance with some embodiments.

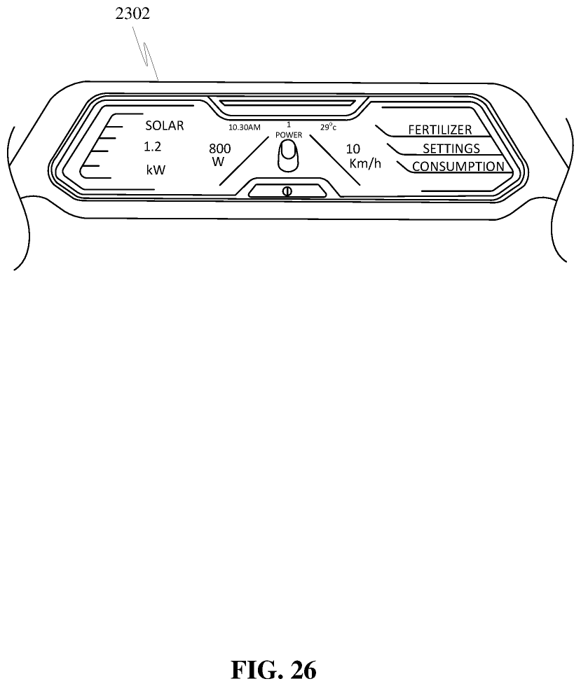

FIG. 26 is a top view of the user panel 2302 of the apparatus 2200, in accordance with some embodiments.

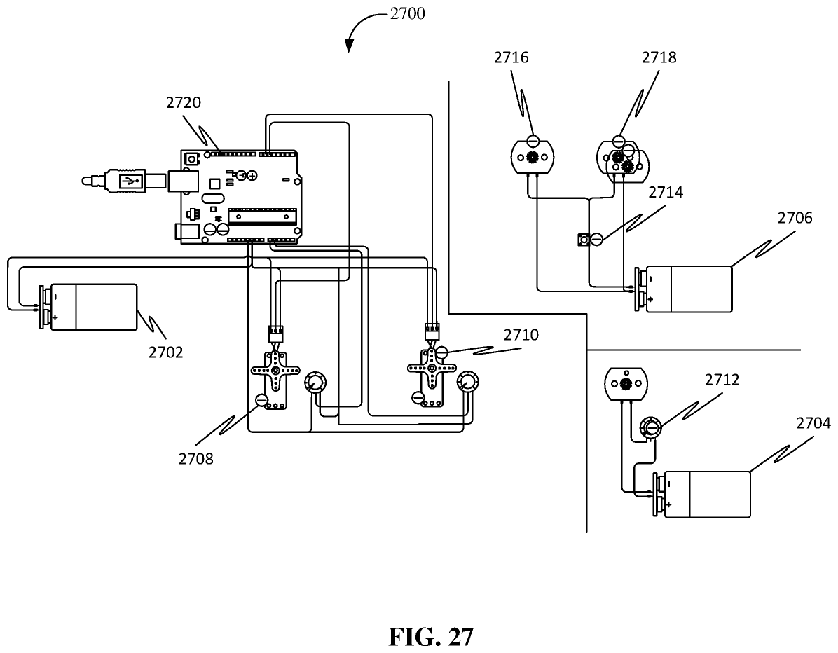

FIG. 27 is a schematic of an electronic circuit 2700 of the apparatus 2200, in accordance with some embodiments. Further, the electronic circuit 2700 may include a fertilizer flow control 2708 connected to a battery 2702 and a microcontroller 2720, a height adjustment control 2710 connected to the battery 2702 and the microcontroller 2720, a fertilizer spreader control 2712 connected to a battery 2704, a front left traction motor 2716, a front right traction motor 2718 connected to a control button 2714, and the control button 2714, the front left traction motor 2716 and the front right traction motor 2718 connected to a battery 2706.

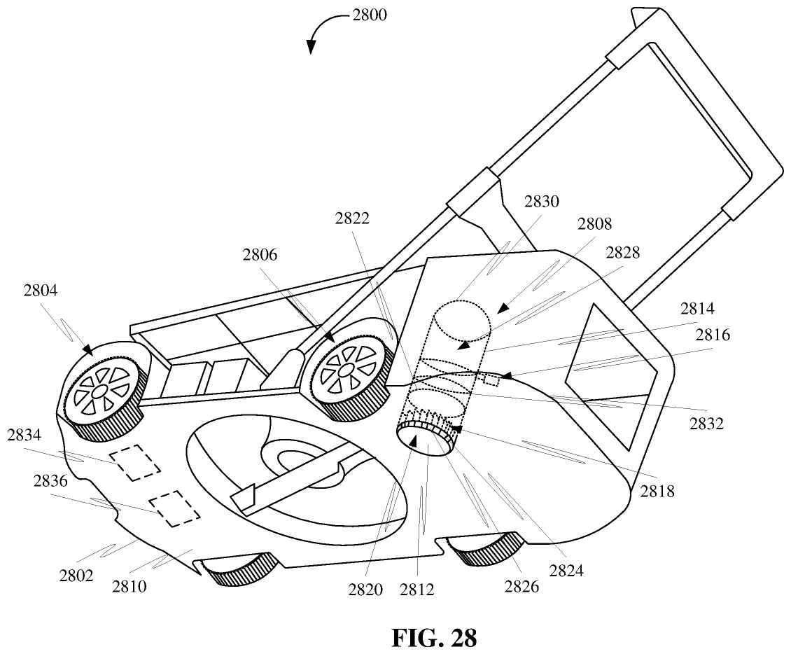

FIG. 28 is a bottom perspective view of an apparatus 2800 for facilitating maintaining of lawns, in accordance with some embodiments. Accordingly, the apparatus 2800 may include a body 2802, a plurality of pairs of wheel assemblies 2804-2806, a material spreading assembly 2808, at least one sensor 2834, and a processing device 2836.

Further, the plurality of pairs of wheel assemblies 2804-2806 may be attached to the body 2802.

Further, the material spreading assembly 2808 may include a bottom container 2812, a top container 2814, a control mechanism 2816, and a spreading mechanism 2818. Further, the bottom container 2812 may be attached to a bottom side 2810 of the body 2802. Further, the bottom container 2812 defines a bottom chamber 2820 including a first inlet 2822 and at least one first outlet 2824-2826. Further, the top container 2814 may be included within the body 2802 above the bottom container 2812. Further, the top container 2814 defines a top chamber 2828 including a second inlet 2830 and a second outlet 2832. Further, the top container 2814 transfers at least one material received into the top chamber 2828 from the second inlet 2830 to the bottom chamber 2820 through the second outlet 2832. Further, the bottom container 2812 receives the at least one material in the bottom chamber 2820 through the first inlet 2822 based on the transferring of the at least one material through the second outlet 2832. Further, the bottom container 2812 dispenses the at least one material received in the bottom chamber 2820 through the at least one first outlet 2824-2826. Further, the control mechanism 2816 may be coupled with the top chamber 2828. Further, the control mechanism 2816 may be configured for allowing the transferring of the at least one material from the top chamber 2828 to the bottom chamber 2820 with a transferring rate. Further, the spreading mechanism 2818 may be disposed in the bottom chamber 2820. Further, the spreading mechanism 2818 may be configured for dispensing the at least one material received in the bottom chamber 2820 through the at least one first outlet 2824-2826 in a dispensing area.

Further, the at least one sensor 2834 may be configured for generating at least one sensor data based on detecting at least one movement characteristic associated with a movement of the apparatus 2800 on at least one surface.

Further, the processing device 2836 may be communicatively coupled with the at least one sensor 2834. Further, the processing device 2836 may be configured for analyzing the at least one sensor data. Further, the processing device 2836 may be configured for determining at least one of the transferring rate and the dispensing area for the movement of the apparatus 2800 based on the analyzing of the at least one sensor data and a requirement of the at least one material for grass associated with at least one lawn. Further, the processing device 2836 may be configured for generating at least one of a first command and a second command for at least one of the control mechanism 2816 and the spreading mechanism 2818 based on the determining. Further, the processing device 2836 may be communicatively coupled to at least one of the control mechanism 2816 and the spreading mechanism 2818. Further, at least one of the allowing of the transferring of the at least one material with the transferring rate and the dispensing of the at least one material in the dispensing area may be based on at least one of the first command and the second command.

Further, in some embodiments, the control mechanism 2816 may include a plate and a first actuator. Further, the plate may be rotatably disposed in the top chamber 2828. Further, the plate may be configured to be rotated to one of a plurality of positions. Further, each of the plurality of positions corresponds to each of a plurality of areas of the second outlet 2832. Further, the first actuator may be operatably coupled with the plate. Further, the first actuator may be configured for rotating the plate to one of the plurality of positions. Further, the allowing of the transferring of the at least one material with the transferring rate may be based on the rotating of the plate to one of the plurality of positions.

Further, in some embodiments, the spreading mechanism 2818 may include an impeller and a second actuator. Further, the impeller may be rotatably disposed in the bottom chamber 2820. Further, the impeller may be configured to be rotated with one of a plurality of speeds. Further, the second actuator operatably coupled with the impeller. Further, the second actuator may be configured for rotating the impeller with one of the plurality of speeds. Further, the dispensing of the at least one material received in the bottom chamber 2820 through the at least one first outlet 2824-2826 in the dispensing area may be based on the rotating of the impeller with one of the plurality of speeds.

Further, in some embodiments, at least one of the plurality of pairs of wheel assemblies 2804-2806 may include at least one pair of wheels and a third actuator. Further, the at least one pair of wheels may be configured to be rotated for moving the apparatus 2800 on at least one surface with a plurality of apparatus speeds. Further, the third actuator may be operatably coupled with the at least one pair of wheels. Further, the third actuator may be configured for rotating the at least one pair of wheels for the moving of the apparatus 2800 with one of the plurality of apparatus speeds.

In further embodiments, the apparatus 2800 may include at least one first sensor. Further, the at least one first sensor may be communicatively coupled with the processing device 2836. Further, the at least one first sensor may be configured for generating at least one first sensor data based on detecting at least one characteristic of the grass associated with the at least one lawn. Further, the processing device 2836 may be configured for analyzing the at least one first sensor data. Further, the processing device 2836 may be configured for generating the requirement of the grass associated with the at least one lawn based on the analyzing of the at least one first sensor data. Further, the analyzing of the at least one sensor data and the requirement may be based on the generating of the requirement.

In further embodiments, the apparatus 2800 may include at least one second sensor and at least one output device. Further, the at least one second sensor may be configured for generating at least one second sensor data based on detecting at least one characteristic of the dispensing area. Further, the 2836 may be communicatively coupled with the at least one second sensor. Further, the processing device 2836 may be configured for analyzing the at least one second sensor data. Further, the processing device 2836 may be configured for generating a path for moving the apparatus 2800 on the at least one lawn based on the analyzing of the at least one second sensor data and the analyzing of the at least one sensor data. Further, the moving of the apparatus 2800 along the path evenly dispenses the at least one material on the grass of the at least one lawn. Further, the at least one output device may be communicatively coupled with the processing device 2836. Further, the at least one output device may be configured for presenting the path.

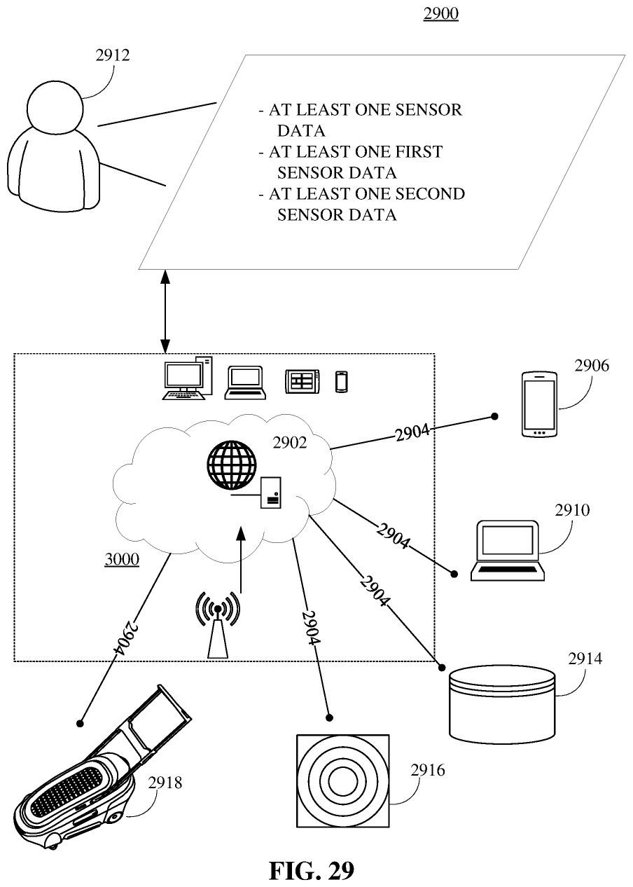

FIG. 29 is an illustration of an online platform 2900 consistent with various embodiments of the present disclosure. By way of non-limiting example, the online platform 2900 to facilitate maintaining of lawns using an apparatus may be hosted on a centralized server 2902, such as, for example, a cloud computing service. The centralized server 2902 may communicate with other network entities, such as, for example, a mobile device 2906 (such as a smartphone, a laptop, a tablet computer, etc.), other electronic devices 2910 (such as desktop computers, server computers, etc.), databases 2914, sensors 2916, and an apparatus 2918 (such as the apparatus 100, the apparatus 1400, the apparatus 2200, the apparatus 2800, etc.) over a communication network 2904, such as, but not limited to, the Internet. Further, users of the online platform 2900 may include relevant parties such as, but not limited to, end-users, administrators, service providers, service consumers and so on. Accordingly, in some instances, electronic devices operated by the one or more relevant parties may be in communication with the platform.

A user 2912, such as the one or more relevant parties, may access online platform 2900 through a web based software application or browser. The web based software application may be embodied as, for example, but not be limited to, a website, a web application, a desktop application, and a mobile application compatible with a computing device 3000.

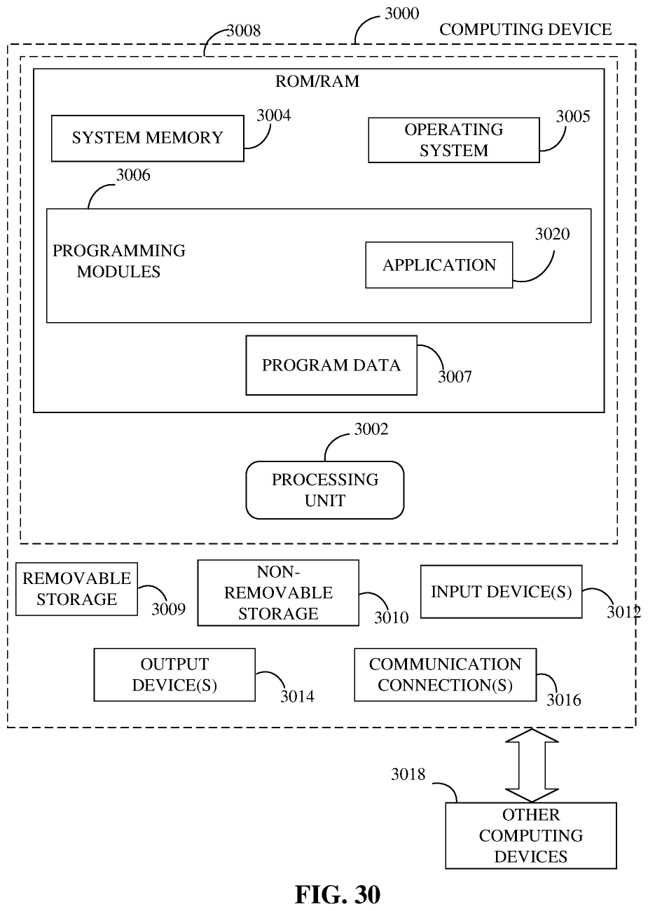

With reference to FIG. 30, a system consistent with an embodiment of the disclosure may include a computing device or cloud service, such as computing device 3000. In a basic configuration, computing device 3000 may include at least one processing unit 3002 and a system memory 3004. Depending on the configuration and type of computing device, system memory 3004 may comprise, but is not limited to, volatile (e.g. random-access memory (RAM)), non-volatile (e.g. read-only memory (ROM)), flash memory, or any combination. System memory 3004 may include operating system 3005, one or more programming modules 3006, and may include a program data 3007. Operating system 3005, for example, may be suitable for controlling computing device 3000's operation. In one embodiment, programming modules 3006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 30 by those components within a dashed line 3008.

Computing device 3000 may have additional features or functionality. For example, computing device 3000 may also include additional data storage devices (removable and/or non-removable) such as, for example, magnetic disks, optical disks, or tape. Such additional storage is illustrated in FIG. 30 by a removable storage 3009 and a non-removable storage 3010. Computer storage media may include volatile and non-volatile, removable and non-removable media implemented in any method or technology for storage of information, such as computer-readable instructions, data structures, program modules, or other data. System memory 3004, removable storage 3009, and non-removable storage 3010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 3000. Any such computer storage media may be part of device 3000. Computing device 3000 may also have input device(s) 3012 such as a keyboard, a mouse, a pen, a sound input device, a touch input device, a location sensor, a camera, a biometric sensor, etc. Output device(s) 3014 such as a display, speakers, a printer, etc. may also be included. The aforementioned devices are examples and others may be used.

Computing device 3000 may also contain a communication connection 3016 that may allow device 3000 to communicate with other computing devices 3018, such as over a network in a distributed computing environment, for example, an intranet or the Internet. Communication connection 3016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 3004, including operating system 3005. While executing on processing unit 3002, programming modules 3006 (e.g., application 3020 such as a media player) may perform processes including, for example, one or more stages of methods, algorithms, systems, applications, servers, databases as described above. The aforementioned process is an example, and processing unit 3002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for facilitating maintaining of lawns, the apparatus comprising:
a body;
a plurality of pairs of wheel assemblies attached to the body; and
a material spreading assembly comprising:
a bottom container attached to a bottom side of the body, wherein the bottom container defines a bottom chamber including a first inlet and at least one first outlet;
a top container comprised within the body above the bottom container, wherein the top container defines a top chamber including a second inlet and a second outlet, wherein the top container transfers at least one material received into the top chamber from the second inlet to the bottom chamber through the second outlet, wherein the bottom container receives the at least one material in the bottom chamber through the first inlet based on the transferring of the at least one material through the second outlet, wherein the bottom container dispenses the at least one material received in the bottom chamber through the at least one first outlet;
a control mechanism coupled with the top chamber, wherein the control mechanism is configured for allowing the transferring of the at least one material from the top chamber to the bottom chamber with a transferring rate; and
a spreading mechanism disposed in the bottom chamber, wherein the spreading mechanism is configured for dispensing the at least one material received in the bottom chamber through the at least one first outlet in a dispensing area.

2. The apparatus of claim 1, wherein the control mechanism comprises:
a plate rotatably disposed in the top chamber, wherein the plate is configured to be rotated to one of a plurality of positions, wherein each of the plurality of positions corresponds to each of a plurality of areas of the second outlet; and
a first actuator operatably coupled with the plate, wherein the first actuator is configured for rotating the plate to one of the plurality of positions, wherein the allowing of the transferring of the at least one material with the transferring rate is based on the rotating of the plate to one of the plurality of positions.

3. The apparatus of claim 2 further comprising a first input device configured for receiving one of a plurality of first inputs associated with the first input device from at least one user, wherein each of the plurality of first inputs corresponds to each of the plurality of positions of the plate, wherein the first actuator is communicatively coupled with the first input device, wherein the rotating of the plate to one of the plurality of positions is based on one of the plurality of first inputs.

4. The apparatus of claim 1, wherein the spreading mechanism comprises:
an impeller rotatably disposed in the bottom chamber, wherein the impeller is configured to be rotated with one of a plurality of speeds; and
a second actuator operatably coupled with the impeller, wherein the second actuator is configured for rotating the impeller with one of the plurality of speeds, wherein the dispensing of the at least one material received in the bottom chamber through the at least one first outlet in the dispensing area is based on the rotating of the impeller with one of the plurality of speeds.

5. The apparatus of claim 4 further comprising a second input device configured for receiving one of a plurality of second inputs associated with the second input device from at least one user, wherein each of the plurality of second inputs corresponds to each of the plurality of speeds associated with the impeller, wherein the second actuator is communicatively coupled with the second input device, wherein the second actuator is operatably coupled with the impeller, wherein the rotating of the impeller with one of the plurality of speeds is based on one of the plurality of second inputs.

6. The apparatus of claim 1 further comprising at least one height adjustment assembly disposed on the body, wherein the height adjustment assembly is operatably coupled with at least one axel of at least one of the plurality of pairs of wheel assemblies, wherein the height adjustment assembly is configured for adjusting a vertical distance between at least one central axis of at least one pair of wheels of at least one of the plurality of pairs of wheel assemblies and a bottom surface of the body.

7. The apparatus of claim 1, wherein at least one of the plurality of pairs of wheel assemblies comprises:
at least one pair of wheels configured to be rotated for moving the apparatus on at least one surface with a plurality of apparatus speeds; and
a third actuator operatably coupled with the at least one pair of wheels, wherein the third actuator is configured for rotating the at least one pair of wheels for the moving of the apparatus with one of the plurality of apparatus speeds.

8. The apparatus of claim 7 further comprising a third input device configured for receiving one of a plurality of third inputs associated with the third input device from at least one user, wherein each of the plurality of third inputs corresponds to each of the plurality of apparatus speeds associated with the apparatus, wherein the third actuator is communicatively coupled with the third input device, wherein the rotating of the at least one pair of wheels for the moving of the apparatus with one of the plurality of apparatus speeds is based on one of the plurality of third inputs.

9. The apparatus of claim 1 further comprising:
at least one sensor configured for generating at least one sensor data based on detecting at least one movement characteristic associated with a movement of the apparatus on at least one surface; and
a processing device communicatively coupled with the at least one sensor, wherein the processing device is configured for:
analyzing the at least one sensor data;
determining at least one of the transferring rate and the dispensing area for the movement of the apparatus based on the analyzing of the at least one sensor data and a requirement of the at least one material for the grass associated with at least one lawn; and
generating at least one of a first command and a second command for at least one of the control mechanism and the spreading mechanism based on the determining, wherein the processing device is communicatively coupled to at least one of the control mechanism and the spreading mechanism, wherein at least one of the allowing of the transferring of the at least one material with the transferring rate and the dispensing of the at least one material in the dispensing area is further based on at least one of the first command and the second command.

10. The apparatus of claim 9 further comprising at least one first sensor communicatively coupled with the processing device, wherein the at least one first sensor is configured for generating at least one first sensor data based on detecting at least one characteristic of the grass associated with the at least one lawn, wherein the processing device is further configured for:
analyzing the at least one first sensor data; and
generating the requirement of the grass associated with the at least one lawn based on the analyzing of the at least one first sensor data, wherein the analyzing of the at least one sensor data and the requirement is further based on the generating of the requirement.

11. The apparatus of claim 9 further comprising at least one input device communicatively coupled with the processing device, wherein the at least one input device is configured for receiving the requirement for the grass associated with the at least one lawn.

12. The apparatus of claim 9 further comprising:
at least one second sensor configured for generating at least one second sensor data based on detecting at least one characteristic of the dispensing area, wherein the processing device is communicatively coupled with the at least one second sensor, wherein the processing device is further configured for:
analyzing the at least one second sensor data; and
generating a path for moving the apparatus on the at least one lawn based on the analyzing of the at least one second sensor data and the analyzing of the at least one sensor data, wherein the moving of the apparatus along the path evenly dispenses the at least one material on the grass of the at least one lawn; and
at least one output device communicatively coupled with the processing device, wherein the at least one output device is configured for presenting the path.

13. An apparatus for facilitating maintaining of lawns, the apparatus comprising:
a body;
a plurality of pairs of wheel assemblies attached to the body;
a material spreading assembly comprising:
a bottom container attached to a bottom side of the body, wherein the bottom container defines a bottom chamber including a first inlet and at least one first outlet;
a top container comprised within the body above the bottom container, wherein the top container defines a top chamber including a second inlet and a second outlet, wherein the top container transfers at least one material received into the top chamber from the second inlet to the bottom chamber through the second outlet, wherein the bottom container receives the at least one material in the bottom chamber through the first inlet based on the transferring of the at least one material through the second outlet, wherein the bottom container dispenses the at least one material received in the bottom chamber through the at least one first outlet;
a control mechanism coupled with the top chamber, wherein the control mechanism is configured for allowing the transferring of the at least one material from the top chamber to the bottom chamber with a transferring rate; and
a spreading mechanism disposed in the bottom chamber, wherein the spreading mechanism is configured for dispensing the at least one material received in the bottom chamber through the at least one first outlet in a dispensing area;
at least one sensor configured for generating at least one sensor data based on detecting at least one movement characteristic associated with a movement of the apparatus on at least one surface; and
a processing device communicatively coupled with the at least one sensor, wherein the processing device is configured for:
analyzing the at least one sensor data;
determining at least one of the transferring rate and the dispensing area for the movement of the apparatus based on the analyzing of the at least one sensor data and a requirement of the at least one material for the grass associated with at least one lawn; and
generating at least one of a first command and a second command for at least one of the control mechanism and the spreading mechanism based on the determining, wherein the processing device is communicatively coupled to at least one of the control mechanism and the spreading mechanism, wherein at least one of the allowing of the transferring of the at least one material with the transferring rate and the dispensing of the at least one material in the dispensing area is further based on at least one of the first command and the second command.

14. The apparatus of claim 13, wherein the control mechanism comprises:
a plate rotatably disposed in the top chamber, wherein the plate is configured to be rotated to one of a plurality of positions, wherein each of the plurality of positions corresponds to each of a plurality of areas of the second outlet; and
a first actuator operatably coupled with the plate, wherein the first actuator is configured for rotating the plate to one of the plurality of positions, wherein the allowing of the transferring of the at least one material with the transferring rate is based on the rotating of the plate to one of the plurality of positions.

15. The apparatus of claim 13, wherein the spreading mechanism comprises:
an impeller rotatably disposed in the bottom chamber, wherein the impeller is configured to be rotated with one of a plurality of speeds; and
a second actuator operatably coupled with the impeller, wherein the second actuator is configured for rotating the impeller with one of the plurality of speeds, wherein the dispensing of the at least one material received in the bottom chamber through the at least one first outlet in the dispensing area is based on the rotating of the impeller with one of the plurality of speeds.

16. The apparatus of claim 13, wherein at least one of the plurality of pairs of wheel assemblies comprises:
at least one pair of wheels configured to be rotated for moving the apparatus on at least one surface with a plurality of apparatus speeds; and
a third actuator operatably coupled with the at least one pair of wheels, wherein the third actuator is configured for rotating the at least one pair of wheels for the moving of the apparatus with one of the plurality of apparatus speeds.

17. The apparatus of claim 16 further comprising a third input device configured for receiving one of a plurality of third inputs associated with the third input device from at least one user, wherein each of the plurality of third inputs corresponds to each of the plurality of apparatus speeds associated with the apparatus, wherein the third actuator is communicatively coupled with the third input device, wherein the rotating of the at least one pair of wheels for the moving of the apparatus with one of the plurality of apparatus speeds is based on one of the plurality of third inputs.

18. The apparatus of claim 13 further comprising at least one height adjustment assembly disposed on the body, wherein the height adjustment assembly is operatably coupled with at least one axel of at least one of the plurality of pairs of wheel assemblies, wherein the height adjustment assembly is configured for adjusting a vertical distance between at least one central axis of at least one pair of wheels of at least one of the plurality of pairs of wheel assemblies and a bottom surface of the body.

19. The apparatus of claim 13 further comprising at least one first sensor communicatively coupled with the processing device, wherein the at least one first sensor is configured for generating at least one first sensor data based on detecting at least one characteristic of the grass associated with the at least one lawn, wherein the processing device is further configured for:
analyzing the at least one first sensor data; and
generating the requirement of the grass associated with the at least one lawn based on the analyzing of the at least one first sensor data, wherein the analyzing of the at least one sensor data and the requirement is further based on the generating of the requirement.

20. The apparatus of claim 13 further comprising:
at least one second sensor configured for generating at least one second sensor data based on detecting at least one characteristic of the dispensing area, wherein the processing device is communicatively coupled with the at least one second sensor, wherein the processing device is further configured for:
analyzing the at least one second sensor data; and
generating a path for moving the apparatus on the at least one lawn based on the analyzing of the at least one second sensor data and the analyzing of the at least one sensor data, wherein the moving of the apparatus along the path evenly dispenses the at least one material on the grass of the at least one lawn; and
at least one output device communicatively coupled with the processing device, wherein the at least one output device is configured for presenting the path.
